(19) United States
(12) Patent Application Publication
(10) Pub. No.: US 2006/0082308 A1
(43) Pub. Date: Apr. 20, 2006

(54) Plasma display panel and method of manufacturing the same

(75) Inventor: Tatsuhiko Kawasaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki (JP)

(21) Appl. No.: 11/247,205

(22) Filed: Oct. 12, 2005

(30) Foreign Application Priority Data
Oct. 19, 2004 (JP) 2004-304499

(51) Int. Cl. H01J 17/49

(52) U.S. Cl. 313/583; 313/582; 313/586; 445/24

(57) ABSTRACT

An AC type plasma display panel includes a front substrate and a rear substrate defining a discharge space therebetween, electrodes formed on the inner surface of the front substrate, a dielectric layer covering the electrodes, and a protective film covering the dielectric layer. The difference in the index of refraction between the dielectric layer and the protective film is not greater than 0.20. According to the present invention, lack of uniformity due to interference is lessened by taking the difference in the index of refraction between a dielectric layer and a protective film into consideration.

### CROSS-REFERENCE TO RELATED APPLICATION

This application is related to Japanese Patent Application No. 2004-304499 filed on Oct. 19, 2004, on the basis of which priority is claimed under 35 USC §119, the disclosure of this application being incorporated by reference in its entirety.

### BACKGROUNF OF THE INVENTION

1. Field of the Invention

The present invention relates to a plasma display panel (hereinafter referred to as “PDP”) and a manufacturing method for the same, and in particular, to a PDP where lack of uniformity in the display is lessened, and a manufacturing method for the same.

2. Description of the Related Art

An AC type 3-electrode surface discharge style PDP is known as a conventional PDP. In this PDP, a great number of display electrodes which allow for surface discharge are provided on the inner surface of a substrate on the front side (display surface side) in a lateral direction, while a great number of address electrodes for selecting a light emitting cell are provided on the inner surface of a substrate on the rear side in a direction that crosses the display electrodes, and cells are provided in the intersections between the display electrodes and the address electrodes.

The display electrodes of the substrate on the front side are covered with a dielectric layer, and a protective film is formed on top of this. The address electrodes of the substrate on the rear side are also covered with a dielectric layer, partitions are formed between the address electrodes, and fluorescent layers are formed between the partitions.

A panel assembly on the front side and a panel assembly on the rear side, which have been fabricated as described above, are made to face each other, and the peripheries are sealed, and after that, a discharge gas is introduced, and thereby, a PDP is fabricated (see Japanese Unexamined Patent Publication H5 (1993)-234519).

In the above described PDP, the display electrodes of the substrate on the front side are covered with a dielectric layer, and a protective film is formed on top of this. In general, the dielectric layer is formed in a thick film process for a film so as to have a thickness of not less than 10 μm, and the protective film is formed in a thin film formation process for a film so as to have a thickness of approximately 1 μm.

Concerning the optical properties of this substrate on the front side, it is known that interference of light occurs because the protective film is a thin film. Such interference properties differ, depending on the film thickness, and therefore, there is lack of uniformity in the transmittance in the substrate on the front side, in the case where there is lack of uniformity in the film thickness of the protective film within the panel surface.

In a PDP, fluorescent bodies emit light due to discharge, and this emitted light transmits through the substrate on the front side so as to display an image. Accordingly, in the case where there is lack of uniformity in the transmittance of the substrate on the front side due to interference, lack of uniformity in the display on the panel is seen (this is referred to as “lack of uniformity due to interference”).

It may be possible to solve this problem of lack of uniformity due to interference by making the film thickness of the protective film uniform. However, it is considered that a difference of 70 nm in the film thickness of the protective film makes the interference pattern shift by half a period, that is, even a difference of 70 nm in the film thickness causes lack of uniformity due to interference. It is expected that in the future, the area of the substrates will be increased and the tact time shortened, together with an increase in the number of PDP's for production, and under such circumstances, it is very difficult to maintain the difference in the film thickness of the protective film for mass produced PDP's within 70 nm.

### SUMMARY OF THE INVENTION

The present invention is provided taking this situation into consideration, and according to the invention, lack of uniformity due to interference is lessened, by adjusting the difference in the index of refraction between the dielectric layer and the protective film, irrespectively of the uniformity in the film thickness of the protective film.

The present invention provides an AC type plasma display panel comprising: a front substrate and a rear substrate defining a discharge space therebetween; electrodes formed on the inner surface of the front substrate; a dielectric layer covering the electrodes; and a protective film covering the dielectric layer, wherein the difference in the index of refraction between the dielectric layer and the protective film is not greater than 0.20.

According to the present invention, the difference in the index of refraction between the dielectric layer and the protective film is not greater than 0.20 in the substrate on the front side, and therefore, a plasma display panel where lack in the uniformity in the display caused by lack of uniformity in the film thickness of the protective film is lessened, and uniformity in whiteness is high can be manufactured.

### BRIEF DESCRIPTION OF THE DRAWINGS

FIG. 1 is an exploded perspective diagram showing portions of the configuration of a PDP in the embodiment of the present invention;

FIG. 2 is a diagram illustrating a state where light transmits through a substrate on the front side;

FIG. 3 is a graph showing the relationship between the wavelength and the transmittance of light that transmits through a substrate;

FIG. 4 is a graph showing the relationship between the difference in the index of refraction Δn and lack of uniformity due to interference;

FIG. 5 is a table showing the indices of refraction of various types of glass materials;

FIG. 6 is a graph showing the correlation between the pressure for film formation and the index of refraction of an MgO film;

FIG. 7 is a graph showing the correlation between the temperature for film formation and the index of refraction of an MgO film;

FIG. 8 is a diagram illustrating a structure where an interference preventing layer is provided in the embodiment of the present invention; and

FIG. 9 is a graph showing the relationship between the center value of the film thickness of the MgO film and lack of uniformity in the display.

### DESCRIPTION OF THE PREFERRED EMBODIMENTS

In the present invention, the index of refraction means the ratio c/v of light velocity c in a vacuum to light velocity (phase velocity) v in a medium. Accordingly, the index of refraction of a dielectric layer means the ratio of light velocity in a vacuum to light velocity in the dielectric layer, and the index of refraction of a protective film means the ratio of light velocity in a vacuum to light velocity in the protective film.

In the present invention, the index of refraction is not defined in size, but rather, the difference in the index of refraction is defined. The difference in the index of refraction between a dielectric layer and a protective film is difference in index of refraction Δn=|n−n₁|, where n is the index of refraction of the dielectric layer and n₁ is the index of refraction of the protective film. Accordingly, either the index of refraction of the dielectric layer or the index of refraction of the protective film may be greater.

In the present invention, the substrate on the front side and the substrate on the rear side include substrates such as glass, quartz and ceramics, as well as substrates where a desired structure, such as electrodes, an insulating film, a dielectric layer or a protective film is formed on these substrates.

Electrodes may be formed on the inner surface of the substrate on the front side. These electrodes can be formed using a variety of materials and methods which are known in the field. Transparent conductive materials, such as ITO and SnO₂, as well as metal conductive materials, such as Ag, Au, Al, Cu and Cr, for example, can be cited as a material used for the electrodes. A variety of methods known in the field can be applied as a method for forming the electrodes. A thick film formation technology, such as printing, for example, may be used, or a thin film formation technology, such as a physical deposition method or a chemical deposition method, may be used in the formation of the electrodes. A screen printing method and the like can be cited for the thick film formation technology. A vapor deposition method, a sputtering method and the like can be cited as the physical deposition method within the thin film formation technology. A thermal CVD method, an optical CVD method, a plasma CVD method and the like can be cited as the chemical deposition method.

A dielectric layer can be formed by applying a low melting point glass paste made of a low melting point glass frit and a binder resin to a substrate on the front side or a substrate on the rear side in accordance with a screen printing method, and baking it. A glass material of which the main component is one material or a mixture of two or more materials selected from the group consisting of silicon oxide, borosilicate glass, aluminum oxide, yttrium oxide and lead oxide can be applied as the low melting point glass used herein.

In the present invention, MgO is used for the protective film, which can be formed in a thin film formation process for forming a film of which the average thickness is approximately 1 μm.

It is desirable for the dielectric layer to be formed of a material that is selected in such a manner that the difference in the index of refraction between this film dielectric layer and the protective film that is formed on top of this becomes not greater than 0.20.

In the case where MgO is used for the protective film which is formed in a thin film formation process for forming a film of which the average thickness is approximately 1 μm, it is desirable for the index of refraction of the dielectric layer to have a value from 1.45 to 1.74 for light of which the wavelength is 500 nm.

The protective film can be formed in a thin film formation process that is known in the field, such as an electron beam vapor deposition method or a plasma CVD method. The index of refraction of protective film may be adjusted by controlling the temperature or the pressure as the film formation conditions at the time of this thin film formation process.

In the present invention, an interference preventing layer may be provided between the dielectric layer and the protective film, in such a manner that the difference in the index of refraction between the interference preventing layer and the dielectric layer, as well as the difference in the index of refraction between the interference preventing layer and the protective film, respectively become not greater than 0.05.

The present invention also provides an AC type plasma display panel comprising: a front substrate and a rear substrate defining a discharge space therebetween; electrodes formed on the inner surface of the front substrate; a dielectric layer covering the electrodes; and a protective film covering the dielectric layer, wherein the film thickness of the protective film is not less than 1200 nm.

The present invention further provides a method of manufacturing an AC type plasma display panel having a front substrate and a rear substrate defining a discharge space therebetween, electrodes formed on the inner surface of the front substrate, a dielectric layer covering the electrodes, and a protective film covering the dielectric layer, the method comprising: forming the protective film in a thin film formation process; and controlling the pressure of forming the protective film in the thin film formation process so that the difference in the index of refraction between the protective film and the dielectric layer becomes not greater than 0.05.

The present invention still further provides a method of manufacturing an AC type plasma display panel having a front substrate and a rear substrate defining a discharge space therebetween, electrodes formed on the inner surface of the front substrate, a dielectric layer covering the electrodes, and a protective film covering the dielectric layer, the method comprising: forming the protective film in a thin film formation process; and controlling the temperature of forming the protective film in the thin film formation process so that the difference in the index of refraction between the protective film and the dielectric layer becomes not greater than 0.05.

In the following, the present invention is described in detail, on the basis of the embodiment shown in the drawings. Here, the present invention is not limited to this, but rather, a variety of modifications are possible.

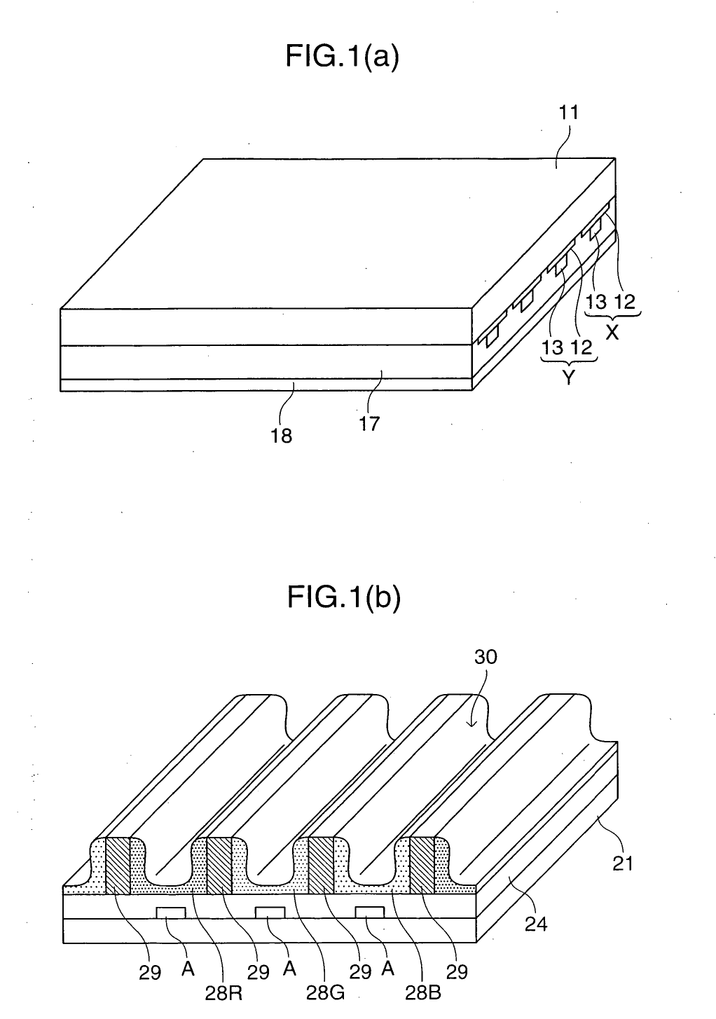

FIGS. 1(a) and 1(b) are an exploded perspective diagram showing portions of the configuration of a PDP according to the present embodiment. This PDP is an AC type 3-electrode surface discharge style PDP for a color display.

This PDP is formed of a panel assembly on the front side (see FIG. 1(a)) that includes a substrate 11 on the front side, and a panel assembly on the rear side (see FIG. 1(b)) that includes a substrate 21 on the rear side. Glass substrates, quartz substrates, ceramic substrates and the like can be utilized as the substrate 11 on the front side and the substrate 21 on the rear side.

Display electrodes, including a display electrode X and a display electrode Y, are formed at equal intervals in the horizontal direction on the inner surface side of the substrate 11 on the front side. A display line L is formed between the display electrode X and the display electrode Y. The display electrodes X and Y are each formed of a transparent electrode 12 having a great width made of ITO, SnO₂ or the like, and a bus electrode 13 having a small width, which is made of a metal, such as Ag, Au, Al, Cu, Cr or a layered body of these (for example, a layered structure of Cr/Cu/Cr). A desired number of display electrodes, including the display electrodes X and Y, having a desired thickness and width can be formed at desired intervals using a thick film formation technology, such as screen printing for Ag or Au films, or a thin film formation technology, such as a vapor deposition method or a sputtering method, and an etching technology for other films.

A dielectric layer 17 for driving an alternating current (AC) is formed on the display electrodes X and Y so as to cover the display electrodes X and Y. The dielectric layer. 17 is formed by applying a low melting point glass paste to the substrate 11 on the front side in accordance with a screen printing method, and baking it.

A protective film 18 for protecting the dielectric layer 17 from the impact of ions that is caused by discharge at the time of display, and thus, preventing it from being damaged, is formed on the dielectric layer 17. This protective film is formed of MgO.

A number of address electrodes A are formed in a direction that crosses the display electrodes X and Y in a plan view on the inner side surface of the substrate 21 on the rear side, and a dielectric layer 24 is formed so as to cover these address electrodes A. The address electrodes A are for generating an address discharge for selecting a light emitting cell at an intersection vis-à-vis the Y electrode, and are formed of a three-layered structure of Cr/Cu/Cr. These address electrodes A can be formed of, for example, Ag, Au, Al, Cu or Cr, in addition to the three-layered structure. A desired number of address electrodes A having a desired thickness and width can be formed at desired intervals, in the same manner as the display electrodes X and Y, using a thick film formation technology, such as screen printing for Ag or Au films, or a thin film formation technology, such as a vapor deposition method or a sputtering method, and an etching technology for other films. The dielectric layer 24 can be formed using the same material and the same method as that for the dielectric layer 17.

A number of partitions 29 are formed on the dielectric layer 24, between the adjacent address electrodes A. The partitions 29 can be formed in accordance with a sandblast method, a printing method, a photo-etching method or the like. In accordance with a sandblast method, for example, a glass paste made of a low melting point glass frit, a binder resin, a solvent and the like is applied to the dielectric layer 24 and dried, and after that, a cutting mask having openings for a partition pattern is provided on this glass paste layer, cutting particles are blasted in this state so that the glass paste layer that has been exposed from the openings of the mask is cut, and in addition, the glass paste layer is baked so as to form the partitions. In addition, in accordance with a photo-etching method, a photosensitive resin is utilized as the binder resin, and the glass paste is exposed to light using a mask and developed, instead of cut with the cutting particles, and after that, the glass paste is baked, so as to form the partitions.

Fluorescent layers 28R, 28G and 28B for red (R), green (G) and blue (B) are formed on the sides of the partitions 29 and on the dielectric layer 24 between the partitions. The fluorescent layers 28R, 28G and 28B are formed by applying a fluorescent paste that includes a fluorescent powder, a binder resin and a solvent to the surfaces within a discharge space in trench form between partitions 29 by means of screen printing, a method using a dispenser or the like, by repeating this for each color, and after that, baking them. These fluorescent layers 28R, 28G and 28B can be formed in accordance with a photolithographic technology using a fluorescent layer material in sheet form (a so-called green sheet) that includes a fluorescent powder, a photosensitive material and a binder resin. In this case, a sheet of a desired color is made to adhere to the entirety of the display region on the substrate, followed by exposure to light and development, and this is repeated for each color, and thereby, fluorescent layers of each color can be formed between corresponding partitions.

A panel assembly on the front side and a panel assembly on the rear side, as described above, are placed so as to face each other in such a manner that the display electrodes X and Y, and the address electrodes A cross, the surroundings are sealed, and the discharge spaces 30 surrounded by the partitions 29 are filled in with a discharge gas, and thereby, a PDP is fabricated. In this PDP, a discharge space 30 at an intersection between the display electrodes X and Y, and an address electrode A becomes one cell region (unit light emitting region) that becomes the minimum unit for the display. One pixel is formed of three cells, R, G and B.

As shown in FIG. 1(a), in the PDP, the display electrodes X and Y on the substrate 11 on the front side is covered with the dielectric layer 17, and the protective film 18 is formed on top of this. This dielectric layer 17 is formed in a thick film process for a film having a thickness of not less than 10 μm. The protective film 18 is formed in a thin film formation process for a film having a thickness of approximately 1 μm.

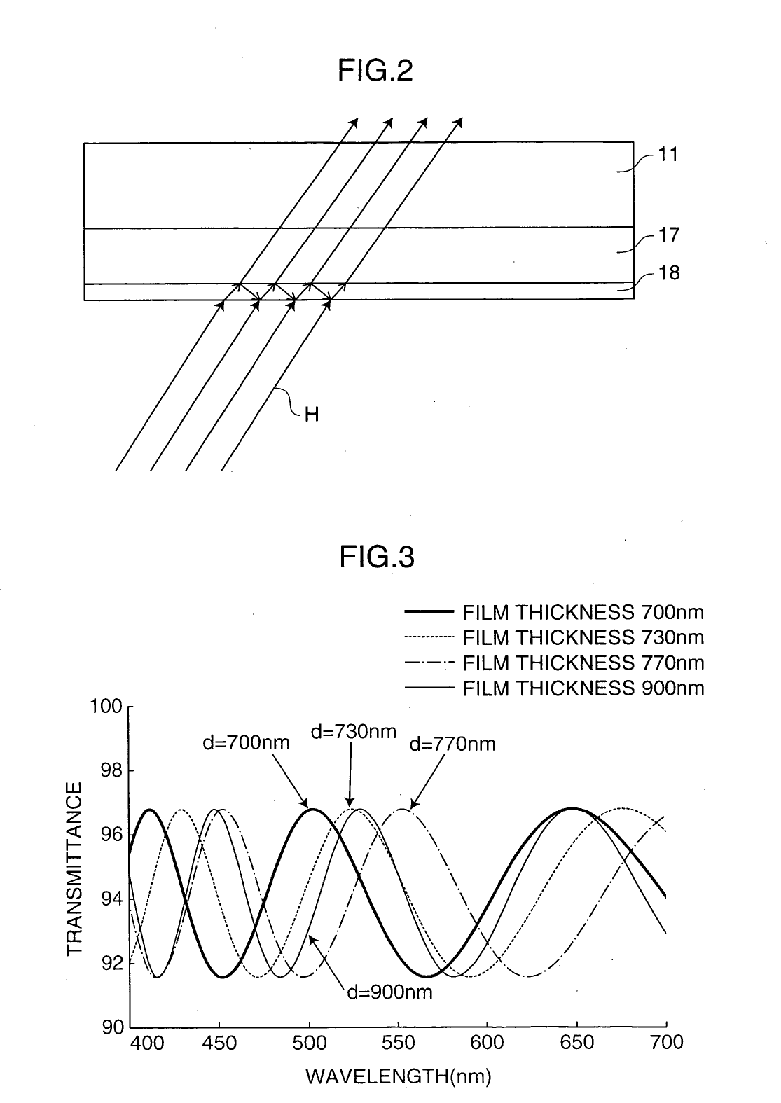

FIG. 2 is a diagram illustrating a state where light transmits through the substrate on the front side.

When, in the substrate 11 on the front side, the index of refraction of air is n₀, the index of refraction of the dielectric layer is n, the index of refraction of the protective film is n₁, and the difference in the index of refraction between the dielectric layer and the protective film is Δn=|n−n₁|, and the transmittance of light of the substrate on the front side is T, the following equation applies:
T=[ (8n₀n₁²n)/{(n₀²+n₁²) (n₁²+n²)+4n₀n₁²n+(n₀²−n₁²) (n₁²−n²) cos δ} ]×α30 β
where α and β are correction coefficients.

The above δ is expressed as follows:
δ=(4nn₁·d·cos φ₁)/λ
where d is the film thickness of the protective film and λ is the wavelength of the transmitting light.

Concerning the optical properties of the substrate 11 on the front side, as shown in FIG. 2, interference of light occurs because the protective film 18 is a thin film. This interference pattern differs depending on the film thickness of the protective film, and therefore, in the case where there is lack of uniformity in the film thickness of the protective film 18 within the surface of the panel, the interference pattern becomes uneven, and there is lack of uniformity in the transmittance of the substrate 11 on the front side.

Fluorescent bodies emit light due to discharge in the PDP, and this emitted light H transmits through the substrate 11 on the front side so as to display an image. Accordingly, in the case where there is lack of uniformity in the transmittance of the substrate 11 on the front side due to unevenness in the interference pattern, lack of uniformity in the display can be seen on the panel. As described above, such lack of uniformity in the display is referred to as “lack of uniformity due to interference.”

FIG. 3 is a graph showing the relationship between the wavelength and the transmittance of light that transmits through the substrate on the front side.

As shown in this figure, a difference of 70 nm in the film thickness of the protective film makes the interference pattern shift by half a period, that is to say, even a difference of 70 nm in the film thickness causes lack of uniformity due to interference. In order to nullify such lack of uniformity due to interference, the film thickness of the protective film 18 may be made uniform. However, it is expected that in the future, the area of the substrates will be increased and the tact time shortened, together with an increase in the number of PDP's for production, and under such circumstances, it is very difficult to maintain the difference in the film thickness of the protective film for mass produced PDP's within 70 nm.

In view of this, the present invention provides a plasma display panel where lack of uniformity in the display caused by lack of uniformity in the film thickness of the protective film is lessened, so as to increase the uniformity of whiteness (uniformity of the panel).

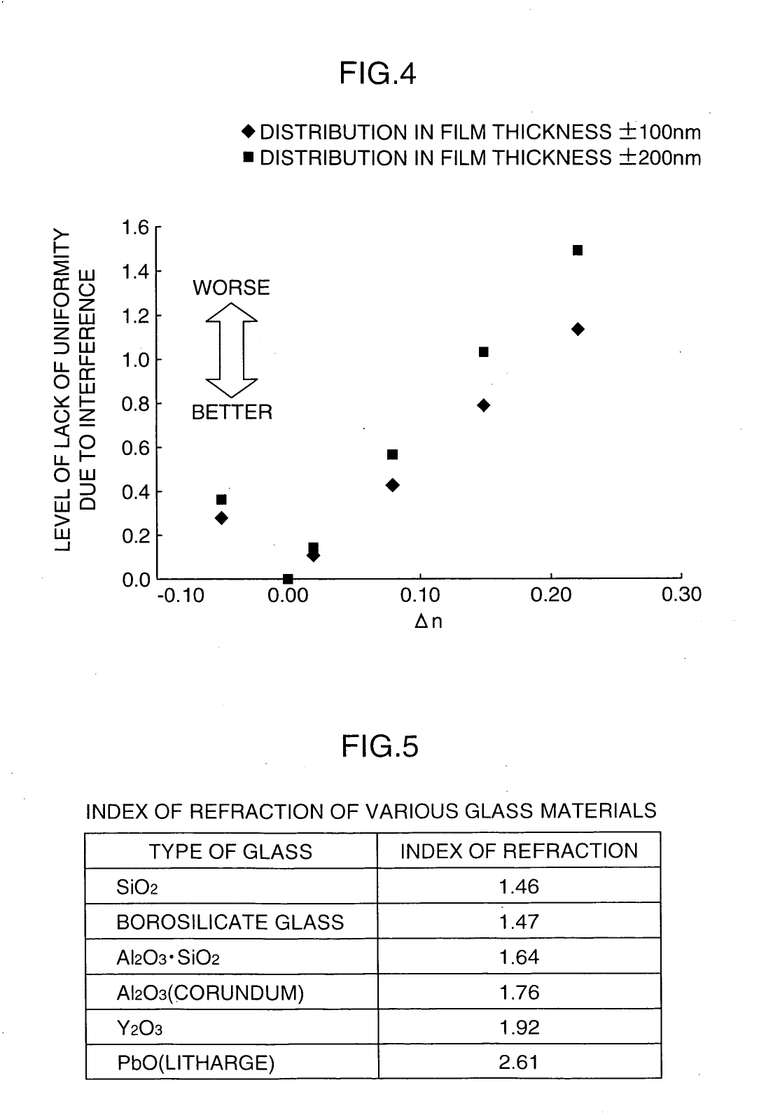

FIG. 4 is a graph showing the relationship between the difference Δn in the index of refraction between the protective film and the dielectric layer, and lack of uniformity due to interference. This graph depicts the correlation between the difference Δn in the index of refraction between the protective film and the dielectric layer, and lack of uniformity due to interference, found as a result of simulation.

The lack of uniformity due to interference is expressed by the level of lack of uniformity that has been calculated using a JND measure. It can be seen that the lack of uniformity due to interference decreases as Δn decreases. This is considered to be because the amplitude of interference decreases as the difference in the index of refraction decreases, and thereby, it becomes practically difficult to perceive lack of uniformity.

In the PDP of the present embodiment, MgO is used for the protective film 18. MgO is a material having an excellent secondary electron discharging coefficient and anti-sputtering properties, and therefore, no material other than MgO is put into practice at present, though alternative materials has been explored. In addition, a low melting point glass is utilized for the dielectric layer 17. Accordingly, the difference Δn in the index of refraction between the MgO film and the dielectric layer is made as small as possible, in order to prevent lack of uniformity due to interference, under the presupposition that MgO is used for the protective film and a low melting point glass material is used for the dielectric layer. Concretely speaking, the difference is made to be not greater than 0.2. In order to do this, the following four measures are implemented.

(1) The index of refraction of the dielectric layer is controlled so as to be closer to the index of refraction of the MgO film.

(2) The index of refraction of the MgO film is controlled so as to be closer to the index of refraction of the dielectric layer.

(3) An interference preventing layer is provided between the MgO film and the dielectric layer, in such a manner that the difference in the index of refraction between the MgO film and the interference preventing layer becomes not greater than 0.05 and the difference in the index of refraction between the interference preventing layer and the dielectric layer becomes not greater than 0.05.

(4) The film thickness of the MgO film is increased so that there is no lack of uniformity due to interference.

First, a concrete method for controlling the index of refraction of the dielectric layer so that the index of refraction of the dielectric layer becomes close to that of the MgO film is described.

FIG. 5 is a table showing the indices of refraction of various glass materials.

The dielectric layer 17 is formed, as described above, by applying a low melting point glass paste to the substrate 11 on the front side in accordance with a screen printing method, and baking it. The index of refraction of this dielectric layer 17 is determined by the composition of the mixture of the low melting point glass. Accordingly, the composition of the dielectric layer is selected so that the difference in the index of refraction between the dielectric layer and the MgO film becomes small, and thereby, lack of uniformity due to interference can be reduced.

In the case where a film is formed of MgO, the index of refraction of this film becomes approximately 1.6 for light having a wavelength of 500 nm, in the case where the film is formed in accordance with a state of the art film formation technology, such as an electron beam vapor deposition method or a plasma CVD method. Concretely, the composition of the dielectric layer is selected so that the index of refraction of the dielectric layer becomes approximately 1.6±0.2. In this case, this index of refraction becomes approximately 1.74 for light having a wavelength of 500 nm when MgO is in bulk form, and therefore, it is not necessary for the index of refraction of the dielectric layer to be greater. Accordingly, when the composition of the dielectric layer is selected, the index of refraction of the dielectric layer may be made to be not less than 1.45 and not greater than 1.74 for light having a wavelength of 500 nm.

In view of this, SiO₂, borosilicate glass, Al₂O₃·SiO₂, Al₂O₃ (corundum), Y₂O₃, PbO (litharge) or the like is used as the low melting point glass material for the dielectric layer. As a result of this, the difference in the index of refraction between the dielectric layer and MgO can be made to be not greater than 0.2, and thus, lack of uniformity due to interference can be reduced.

Here, in the case where SiO₂ is utilized and the dielectric layer is formed in accordance with a plasma CVD method, it is possible to control the index of refraction of the dielectric layer by adjusting the CVD process conditions (such as temperature and pressure), so that the index of refraction of the dielectric layer becomes closer to the index of refraction of the MgO film, thus making the difference in the index of refraction between the two smaller.

Next, a concrete method for controlling the index of refraction of the MgO film so that the index of refraction of the MgO film becomes close to that of the dielectric layer is described.

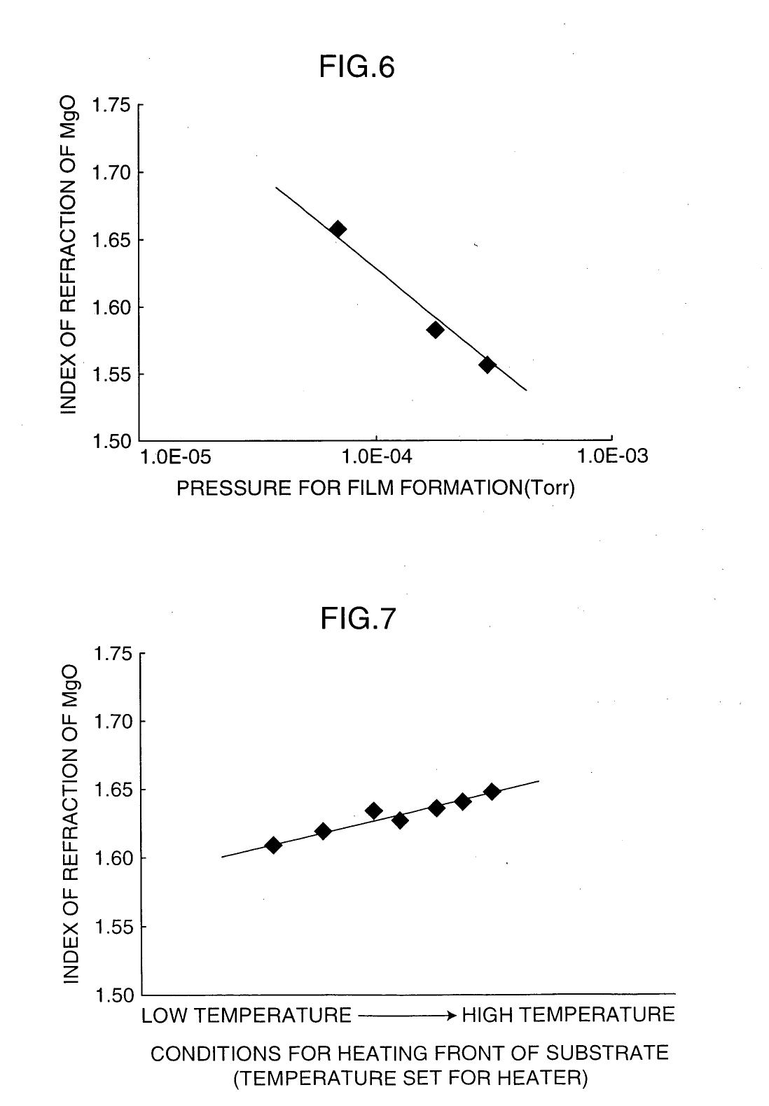

FIG. 6 is a graph showing the correlation between the pressure and the index of refraction when an MgO film is formed.

The film formation is carried out in accordance with an electron beam vapor deposition method. It can be seen from this graph that the higher the pressure for film formation becomes, the lower the index of refraction becomes. Accordingly, when the index of refraction of the dielectric layer has a value from 1.74 to 1.45, the pressure for film formation of MgO is controlled so that the difference in the index of refraction between the MgO film and the dielectric layer can be reduced, concretely, to a value that is not greater than 0.05, and thereby, lack of uniformity due to interference can be reduced.

FIG. 7 is a graph showing the correlation between the temperature for heating the front of a substrate and the index of refraction when an MgO film is formed.

The film formation is carried out in accordance with an electron beam vapor deposition method. It can be seen from this graph that the higher the temperature for heating the front of a substrate becomes, the higher the index of refraction becomes. Accordingly, when the index of refraction of the dielectric layer has a value from. 1.74 to 1.45, the temperature for heating the front of a substrate at the time of the film formation of MgO is controlled so that the difference in the index of refraction between the MgO film and the dielectric layer can be reduced, concretely, to a value that is not greater than 0.05, and thereby, lack of uniformity due to interference can be reduced.

Next, a concrete example where an interference preventing layer is provided between the MgO film and the dielectric layer is described.

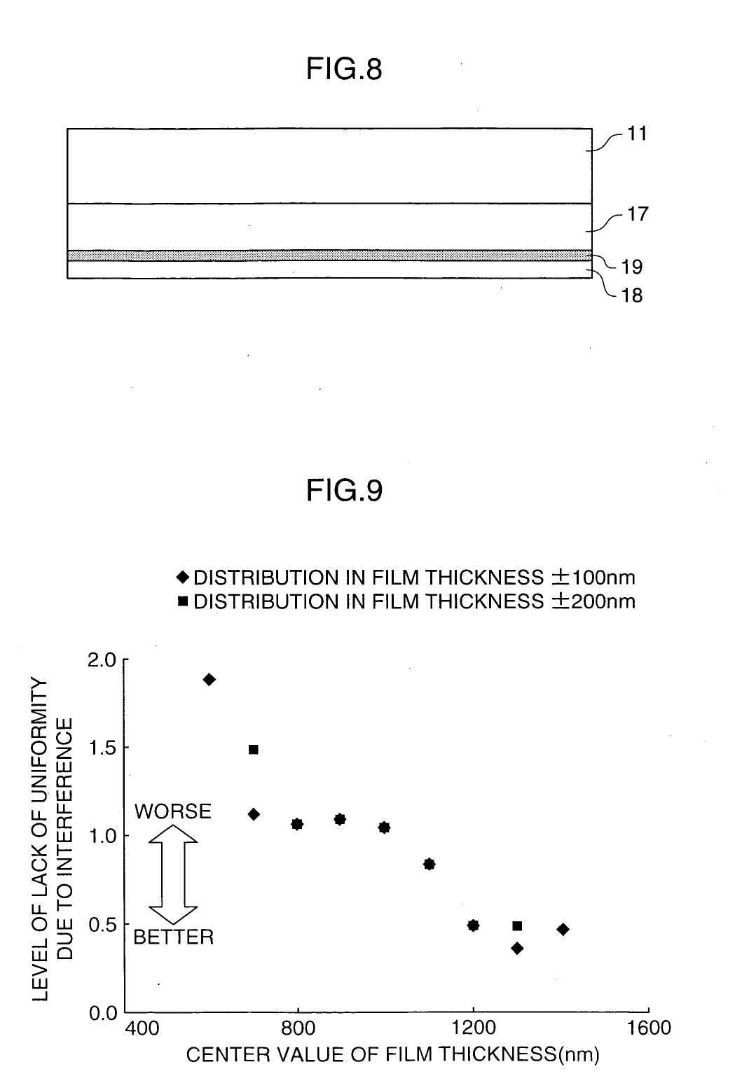

FIG. 8 is a diagram illustrating a structure where an interference preventing layer is provided between a dielectric layer and a protective film.

An interference preventing layer 19 is provided between a dielectric layer 17 and a protective film 18 of a substrate 11 on the front side, in such a manner that the difference in the index of refraction between the interference preventing layer and the dielectric layer 17, as well as the difference in the index of refraction between the interference preventing layer and the protective film 18 respectively become not greater than 0.05. In this manner, an interference preventing layer 19 having an index of refraction of which the value is between those of the dielectric layer 17 and the MgO film 18 is selected. The film thickness of the interference preventing layer 19 is not greater than 200 nm. Any of the various types of glass material shown in FIG. 5 can be applied as the material for the interference preventing layer 19.

The existence of the interference preventing layer 19 allows the difference in the index of refraction in the interfaces to be small, and as a result, lack of uniformity due to interference can be reduced. Conventional materials for the dielectric layer and the protective film, as well as conventional process conditions, can be used, and therefore, this embodiment has the advantage of having a small burden of development and manufacture, even though the number of steps in the manufacture increases.

In addition, MgO, which is a material for a protective film, can be used for the interference preventing layer. That is to say, after the film formation of MgO in such a manner that the difference in the index of refraction between the dielectric layer and the MgO film becomes not greater than 0.05, an MgO film is sequentially formed under different conditions. As a result of this, it becomes unnecessary to increase the number of steps in the manufacture, and it becomes possible to form the MgO film as an upper layer, taking the discharge properties and lifetime of the panel into consideration. This can be implemented by changing the process conditions (the above described pressure and temperature for film formation) only during the process of film formation of MgO having an initial film thickness of approximately 200 nm in accordance with a concrete manufacturing method.

Next, a concrete example where the film thickness of the MgO film is made great so that there is no lack of uniformity due to interference is described.

FIG. 9 is a graph showing the correlation between the center value of the film thickness of the MgO film and lack of uniformity in the display, found as a result of simulation.

It can be seen from this graph that the greater the film thickness of the MgO film, the smaller lack of uniformity in the display becomes. This is considered to be because the period of interference of the transmittance becomes shorter as the film thickness of the MgO film increases.

A PDP performs display using light emission of R (red), G (green) and B (blue), where the spectrum of the emitted light of each color has a certain range of wavelengths. Accordingly, even in the case where the transmittance changes as a result of interference, a great change in color does not occur, as long as the period of interference is within the range of wavelengths of the spectrum of the emitted light of each color. As can be seen from the graph of FIG. 9, lack of uniformity due to interference can be greatly reduced in the case where the thickness of the MgO film is not less than 1200 nm.

As described above, the difference in the index of refraction between the dielectric layer and the protective film is made to be not greater than 0.2, and thereby, lack of uniformity in the display due to lack of uniformity in the film thickness of the protective film can be reduced, and a plasma display panel having high uniformity of whiteness can be provided.

What is claimed is:

1. An AC type plasma display panel comprising:
a front substrate and a rear substrate defining a discharge space therebetween;
electrodes formed on the inner surface of the front substrate;
a dielectric layer covering the electrodes; and
a protective film covering the dielectric layer,
wherein the difference in the index of refraction between the dielectric layer and the protective film is not greater than 0.20.

2. The plasma display panel according to claim 1, wherein the protective film is formed of MgO, by a thin film formation process for forming a film of which the average thickness is approximately 1 μm.

3. The plasma display panel according to claim 1, wherein the dielectric layer is formed of a material that is selected so that the difference in the index of refraction between the dielectric layer and the protective film that is formed on top of this becomes not greater than 0.20.

4. The plasma display panel according to claim 2, wherein the index of refraction of the dielectric layer has a value from 1.45 to 1.74 for light of which the wavelength is 500 nm.

5. The plasma display panel according to claim 1, wherein the dielectric layer is formed of a glass material of which the main component is one material or a mixture of two or more materials selected from the group consisting of silicon oxide, borosilicate glass, aluminum oxide, yttrium oxide and lead oxide.

6. The plasma display panel according to claim 1, wherein the protective film is formed in a thin film formation process, and the index of refraction of the protective film is adjusted by controlling the temperature or the pressure as the film formation conditions in the thin film formation process.

7. The plasma display panel according to claim 1, wherein an interference preventing layer is provided between the dielectric layer and the protective film, in such a manner that the difference in the index of refraction between the dielectric layer and the interference preventing layer and the difference in the index of refraction between the interference preventing layer and the protective film, respectively become not greater than 0.05.

8. An AC type plasma display panel comprising:
a front substrate and a rear substrate defining a discharge space therebetween;
electrodes formed on the inner surface of the front substrate;
a dielectric layer covering the electrodes; and
a protective film covering the dielectric layer,
wherein the film thickness of the protective film is not less than 1200 nm.

9. A method of manufacturing an AC type plasma display panel having a front substrate and a rear substrate defining a discharge space therebetween, electrodes formed on the inner surface of the front substrate, a dielectric layer covering the electrodes, and a protective film covering the dielectric layer, the method comprising:
forming the protective film in a thin film formation process; and
controlling the pressure of forming the protective film in the thin film formation process so that the difference in the index of refraction between the protective film and the dielectric layer becomes not greater than 0.05.

10. A method of manufacturing an AC type plasma display panel having a front substrate and a rear substrate defining a discharge space therebetween, electrodes formed on the inner surface of the front substrate, a dielectric layer covering the electrodes, and a protective film covering the dielectric layer, the method comprising:
forming the protective film in a thin film formation process; and
controlling the temperature of forming the protective film in the thin film formation process so that the difference in the index of refraction between the protective film and the dielectric layer becomes not greater than 0.05.
